(19) United States
(12) Patent Application Publication
(10) Pub. No.: US 2026/0220657 A1
(43) Pub. Date: Jul. 30, 2026

(54) SYSTEM AND METHOD FOR LOW POWER MULTI-HORIZON TIME SERIES FORECASTING WITH INTERPRETABILITY

(71) Applicant: JPMorgan Chase Bank, N.A., New York, NY (US)

(72) Inventors: Sikha PENTYALA, Seattle, WA (US); Shubham SHARMA, Manhattan, NY (US); Emanuele ALBINI, London (GB); Leonidas TSEPENEKAS, College Park, MD (US); Saumitra MISHRA, London (GB); Freddy LECUE, Mamaroneck, NY (US)

(73) Assignee: JPMorgan Chase Bank, N.A., New York, NY (US)

(21) Appl. No.: 19/076,251

(22) Filed: Mar. 11, 2025

(30) Foreign Application Priority Data
Jan. 24, 2025 (GR) 20250100054

(51) Int. Cl. G06Q 30/0202

(52) U.S. Cl. CPC G06Q 30/0202

(57) ABSTRACT

A method for performing a multi-horizon forecast is provided, and may include: first feature scoring first information including past targets, past covariates, and static information, the first featuring scoring providing a relevance score for at least some features considered by the first feature scoring; past learning at least some results of the first feature scoring; time projecting at least some results of the first feature scoring; second feature scoring second information including future covariates, the second feature scoring providing a relevance score for at least some features considered by the second feature scoring; future learning a combination of at least some results of the time projecting and the second feature scoring; merging at least some results of the future learning and the past learning; outputting a forecast based on a least some results of the merging. The relevance scores provide interpretability for the forecast.

### CROSS REFERENCE TO RELATED APPLICATIONS

The instant Application claims priority to Greek application No. 20250100054 entitled SYSTEM AND METHOD FOR LOW POWER MULTI-HORIZON TIME SERIES FORECASTING WITH INTERPRETABILITY, filed Jan. 24, 2025, the contents of which are expressly incorporated herein by reference in its entirety.

### TECHNICAL FIELD

The instant Application relates to a low power multi-horizon time forecasting methodology that provides interpretability including relevance scoring of features considered by the forecasting methodology.

### BACKGROUND

Developments described in this section are known to the inventors. However, unless otherwise indicated, it should not be assumed that any of the developments described in this section qualify as prior art merely by virtue of their inclusion in this section, or that these developments are known to a person of ordinary skill in the art.

Multi-horizon time series forecasting is the process of predicting multiple future time steps at once rather than just a single point in time. In many real-world applications, such as energy demand forecasting, financial market prediction, or supply chain management, it is crucial to generate predictions for several future periods simultaneously rather than only forecasting the next time step. This task requires models to capture the short-term patterns and fluctuations in the data and account for longer-term trends and dependencies.

There are two desirable features in multi-horizon time forecasting: accuracy and interpretability. Interpretability refers to the forecast providing information to allow users to understand, explain, and trust the predictions made by the forecasting model. The forecasting model provides some information to describe how it arrived at its forecast and the transparency of the underlying factors driving the predictions. Interpretability is particularly important in decision-making contexts where stakeholders need to understand why a forecast was made, not just what the forecast is. Lack of interpretability can lead to skepticism and reluctance to act on model outputs, especially in high-stakes decision-making areas like finance, healthcare, or energy forecasting.

A technical problem in the art is the power requirements and resources necessary to provide interpretability in forecasts. Consumption of electrical power and the corresponding use of computer resources for AI and ML models has become a known problem, with a typical AI inquiry requiring over ten times the power of a standard Google search. It has been well reported that Microsoft recently entered an arrangement to reopen the Three Mile Island nuclear power plant to provide electricity for its AI operations.

This technical problem of power consumption is present in existing multi-forecasting time forecasting products. Specifically, two well-known products are SparseTSF and TFT. SparseTSF has a relatively low cost because it has a small number of trainable parameters and can generate accurate forecasts for relatively smaller amounts of computer resources and corresponding power consumption, but does not consider a wide array of features (static and dynamic covariates) in modeling or provide information for interpretability purposes. TFT provides both accuracy and information for interpretability purposes, yet has a relatively high cost in that it has a large number of trainable parameters that consumes relatively larger amounts of computer resources and corresponding power.

There is a need for a multi-horizon time series forecasting that provides higher interpretability akin to TFT, but at lower power and resource consumption than TFT and more akin to SparseTSF.

### SUMMARY

The present disclosure, through one or more of its various aspects, embodiments, and/or specific features or sub-components, provides, among other features, various systems, servers, devices, methods, media, programs, and platforms for using an AI/ML model to support a low power multi-horizon time forecasting methodology that provides interpretability including relevance scoring of features considered by the forecasting methodology.

According to an aspect of the present disclosure, a method for performing a multi-horizon forecast is provided. The method may include: first feature scoring first information, the first information including past targets, past covariates, and static information, the first featuring scoring providing a relevance score for at least some features considered by the first feature scoring; past learning at least some results of the first feature scoring; time projecting at least some results of the first feature scoring; second feature scoring second information, the second information including future covariates, the second feature scoring providing a relevance score for at least some features considered by the second feature scoring; future learning a combination of at least some results of the time projecting and the second feature scoring; merging at least some results of the future learning and the past learning; outputting a forecast based on a least some results of the merging; and wherein the relevance scores provided by the first feature scoring and the second feature scoring provides interpretability for the forecast.

The above aspect may have various features. The first feature scoring may be independent of the future covariates. The first feature scoring may include first feature classifying the first information through a first feature classification layer; first aggregating at least some of the results of the first feature classifying with a first aggregator; first normalizing at least some of the results of the first aggregating; and first multiplying at least some of the results of the first feature classifying with at least some of the results of the first normalizing. The first normalizing may output the relevance scores of the past targets, the past covariates, and static information. The second feature scoring may be independent of the past targets, the past covariates, and the static information. The second feature scoring may include: second feature classifying the first information through a second feature classification layer; second aggregating at least some of the results of the second feature classifying with a second aggregator; second normalizing at least some of the results of the second aggregating; and second multiplying at least some of the results of the second feature classifying with at least some of the results of the second normalizing. The second normalizing may output the relevance scores of the future covariates. The merging may include applying cross attention to at least some of the output of the past learning and the future learning. The method may establish matrix formats as follows: the past targets may have a sequence length L and a number of targets C, and the first feature scoring had an associated predetermined hidden dimension H; an output of the first feature scoring may be a first matrix with dimensions of L×H; an output of the past learning may be a second matrix with dimensions of L×H; an output of the time projecting may be a third matrix with dimensions of T×H, where T is a predetermined prediction length; an output of the future learning may be a fourth matrix with dimensions of T×H; an output of the merging may be a fifth matrix with dimensions of T×H; and an output of the outputting may be a sixth matrix with dimensions of T×C.

According to an aspect of the present disclosure, a non-transitory computer readable media storing instructions programmed to cooperate with a processor to perform operations is provided. The operations may include: first feature scoring first information, the first information including past targets, past covariates, and static information, the first featuring scoring providing a relevance score for at least some features considered by the first feature scoring; past learning at least some results of the first feature scoring; time projecting at least some results of the first feature scoring; second feature scoring second information, the second information including future covariates, the second feature scoring providing a relevance score for at least some features considered by the second feature scoring; future learning a combination of at least some results of the time projecting and the second feature scoring; merging at least some results of the future learning and the past learning; outputting a forecast based on a least some results of the merging; and wherein the relevance scores provided by the first feature scoring and the second feature scoring provides interpretability for the forecast.

The above aspect may have various features. The first feature scoring may be independent of the future covariates. The first feature scoring may include first feature classifying the first information through a first feature classification layer; first aggregating at least some of the results of the first feature classifying with a first aggregator; first normalizing at least some of the results of the first aggregating; and first multiplying at least some of the results of the first feature classifying with at least some of the results of the first normalizing. The first normalizing may output the relevance scores of the past targets, the past covariates, and static information. The second feature scoring may be independent of the past targets, the past covariates, and the static information. The second feature scoring may include: second feature classifying the first information through a second feature classification layer; second aggregating at least some of the results of the second feature classifying with a second aggregator; second normalizing at least some of the results of the second aggregating; and second multiplying at least some of the results of the second feature classifying with at least some of the results of the second normalizing. The second normalizing may output the relevance scores of the future covariates. The merging may include applying cross attention to at least some of the output of the past learning and the future learning. The operations may establish matrix formats as follows: the past targets may have a sequence length L and a number of targets C, and the first feature scoring had an associated predetermined hidden dimension H; an output of the first feature scoring may be a first matrix with dimensions of L×H; an output of the past learning may be a second matrix with dimensions of L×H; an output of the time projecting may be a third matrix with dimensions of T×H, where T is a predetermined prediction length; an output of the future learning may be a fourth matrix with dimensions of T×H; an output of the merging may be a fifth matrix with dimensions of T×H; and an output of the outputting may be a sixth matrix with dimensions of T×C.

According to an aspect of the present disclosure, a system is provided. The system includes a processor and a non-transitory computer readable media storing instructions programmed to cooperate with a processor to perform operations. The operations may include: first feature scoring first information, the first information including past targets, past covariates, and static information, the first featuring scoring providing a relevance score for at least some features considered by the first feature scoring; past learning at least some results of the first feature scoring; time projecting at least some results of the first feature scoring; second feature scoring second information, the second information including future covariates, the second feature scoring providing a relevance score for at least some features considered by the second feature scoring; future learning a combination of at least some results of the time projecting and the second feature scoring; merging at least some results of the future learning and the past learning; outputting a forecast based on a least some results of the merging; and wherein the relevance scores provided by the first feature scoring and the second feature scoring provides interpretability for the forecast.

The above aspect may have various features. The first feature scoring may be independent of the future covariates. The first feature scoring may include first feature classifying the first information through a first feature classification layer; first aggregating at least some of the results of the first feature classifying with a first aggregator; first normalizing at least some of the results of the first aggregating; and first multiplying at least some of the results of the first feature classifying with at least some of the results of the first normalizing. The first normalizing may output the relevance scores of the past targets, the past covariates, and static information. The second feature scoring may be independent of the past targets, the past covariates, and the static information. The second feature scoring may include: second feature classifying the first information through a second feature classification layer; second aggregating at least some of the results of the second feature classifying with a second aggregator; second normalizing at least some of the results of the second aggregating; and second multiplying at least some of the results of the second feature classifying with at least some of the results of the second normalizing. The second normalizing may output the relevance scores of the future covariates. The merging may include applying cross attention to at least some of the output of the past learning and the future learning. The operations may establish matrix formats as follows: the past targets may have a sequence length L and a number of targets C, and the first feature scoring had an associated predetermined hidden dimension H; an output of the first feature scoring may be a first matrix with dimensions of L×H; an output of the past learning may be a second matrix with dimensions of L×H; an output of the time projecting may be a third matrix with dimensions of T×H, where T is a predetermined prediction length; an output of the future learning may be a fourth matrix with dimensions of T×H; an output of the merging may be a fifth matrix with dimensions of T×H; and an output of the outputting may be a sixth matrix with dimensions of T×C.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for using an AI/ML model in accordance with an embodiment.

FIG. 2 illustrates an exemplary diagram of a network environment with a device for using an AI/ML model in accordance with an embodiment.

FIG. 3 illustrates a system diagram for implementing a method for using an AI/ML model in accordance with an embodiment.

FIG. 4 illustrates an exemplary flow chart of a process for using an AI/ML model to support a low power multi-horizon time forecasting methodology that provides interpretability including relevance scoring of features considered by the forecasting methodology, in accordance with an embodiment.

FIG. 5 illustrates a matrix layout of various inputs to a forecasting model, in accordance with an embodiment.

FIG. 6 illustrates a data flow that corresponds to a process for using an forecasting model, in accordance with an embodiment.

FIG. 7 illustrates a data flow of a feature scoring module, in accordance with an embodiment.

FIG. 8 illustrates a data flow of a learning module, in accordance with an embodiment.

FIG. 9 illustrates a data flow of a time projecting module, in accordance with an embodiment.

FIG. 10 illustrates a data flow of a merger module, in accordance with an embodiment.

FIG. 11 illustrates a data flow of an output module, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

A technical problem in the art is the power requirements and resources necessary to provide interpretability in forecasts. Consumption of electrical power and the corresponding use of computer resources for AI and ML models has become a known problem, with a typical AI inquiry requiring over ten times the power of a standard Google search. It has been well reported that Microsoft recently entered an arrangement to reopen the Three Mile Island nuclear power plant to provide electricity for its AI operations.

This technical problem of power consumption is present in existing multi-forecasting time forecasting products. Specifically, two well-known products are SparseTSF and TFT. SparseTSF has a relatively low cost because it has a small number of trainable parameters and can generate accurate forecasts for relatively smaller amounts of computer resources and corresponding power consumption, but it does not consider a wide array of features (static and dynamic covariates) in modeling or provide information for interpretability purposes. TFT provides both accuracy and information for interpretability purposes, yet has a relatively high cost in that it has a large number of trainable parameters that consumes relatively larger amounts of computer resources and corresponding power.

A technical solution to this problem is provided by, inter alia, a methodology. The methodology may include: first feature scoring first information, the first information including past targets, past covariates, and static information, the first featuring scoring providing a relevance score for at least some features considered by the first feature scoring; past learning at least some results of the first feature scoring; time projecting at least some results of the first feature scoring; second feature scoring second information, the second information including future covariates, the second feature scoring providing a relevance score for at least some features considered by the second feature scoring; future learning a combination of at least some results of the time projecting and the second feature scoring; merging at least some results of the future learning and the past learning; outputting a forecast based on a least some results of the merging; and wherein the relevance scores provided by the first feature scoring and the second feature scoring provides interpretability for the forecast.

The above methodology provides a technical solution to the technical problems of the prior art. The feature scorer modules provide relevance scores for the input parameters, such that the methodology provides a high degree of interpretability consistent with TFT and much higher than SparseTSF. It achieves this with fewer parameters than TFT (on the order of less than 5% of TFT's parameters), with training time per epoch consistent with SparseTSF and on the order of 30+% lower than TFT. The methodology thus provides interpretability information on par with TFT for only a fraction of the computer resources and electrical power requirements of TFT.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Several definitions that apply throughout this disclosure will now be presented.

The terms “substantial”, “substantially” or the like are defined to be essentially conforming to the particular dimension, shape, or other feature that the term modifies, such that the component need not be exact. For example, “substantially cylindrical” means that the object resembles a cylinder, but can have one or more deviations from a true cylinder. The terms are used as a modifier to imply “approximate” rather than “perfect.” It is a term of approximation, not a term of degree.

The term “comprising” when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which±5% may be expected.

“First,” “second,” etc., re labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

As used herein, the term “front”, “rear”, “left,” “right,” “top” and “bottom” or other terms of direction, orientation, and/or relative position are used for explanation and convenience to refer to certain features of this disclosure. However, these terms are not absolute and should not be construed as limiting this disclosure.

All temperatures herein are in Celsius unless otherwise specified.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

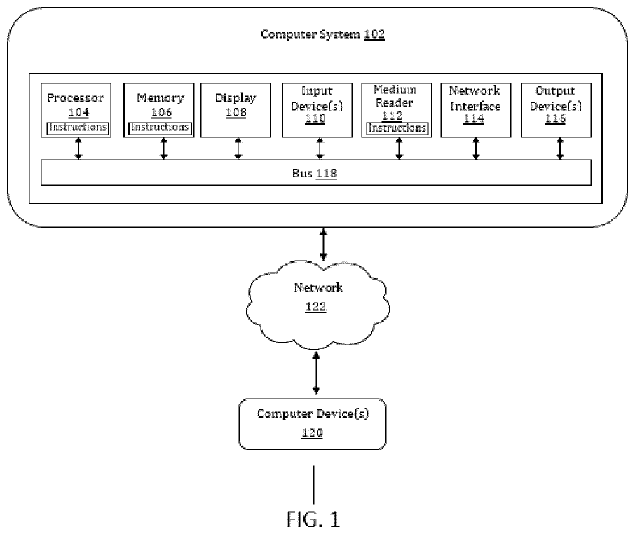

FIG. 1 is an exemplary system 100 for use in implementing a method for using an AI/ML model to support a low power multi-horizon time forecasting methodology that provides interpretability including relevance scoring of features considered by the forecasting methodology, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain′t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

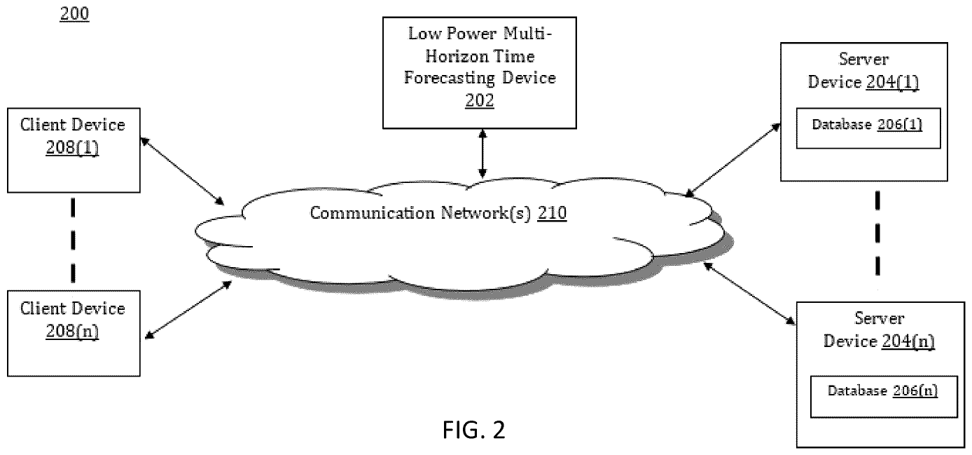

Referring to FIG. 2, a schematic of an exemplary network environment 200 for implementing support a low power multi-horizon time forecasting device (LPMHTFD) that provides interpretability including relevance scoring of features considered by the forecasting methodology of the instant disclosure is illustrated.

In some embodiments, the above-described problems associated with conventional tools may be overcome by implementing an LPMHTFD 202 as illustrated in FIG. 2 that may be configured for implementing a method for using an AI/ML model to support low power multi-horizon time forecasting that provides interpretability including relevance scoring of features considered by the forecasting methodology of the instant disclosure is illustrated, but the disclosure is not limited thereto.

The LPMHTFD 202 may have one or more computer system 102s, as described with respect to FIG. 1, which in aggregate provide the necessary functions.

The LPMHTFD 202 may store one or more applications that can include executable instructions that, when executed by the LPMHTFD 202, cause the LPMHTFD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the LPMHTFD 202 itself, may be located in virtual server(s) running in a cloud-based computing environment rather than being tied to one or more specific physical network computing devices. Also, the application(s) may be running in one or more virtual machines (VMs) executing on the LPMHTFD 202. Additionally, in one or more embodiments of this technology, virtual machine(s) running on the LPMHTFD 202 may be managed or supervised by a hypervisor.

In the network environment 200 of FIG. 2, the LPMHTFD 202 is coupled to a plurality of server devices 204(1)-204(n) that hosts a plurality of databases 206(1)-206(n), and also to a plurality of client devices 208(1)-208(n) via communication network(s) 210. A communication interface of the LPMHTFD 202, such as the network interface 114 of the computer system 102 of FIG. 1, operatively couples and communicates between the LPMHTFD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the LPMHTFD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The LPMHTFD 202 may be a standalone device or integrated with one or more other devices or apparatuses, such as one or more of the server devices 204(1)-204(n), for example. In one particular example, the LPMHTFD 202 may be hosted by one of the server devices 204(1)-204(n), and other arrangements are also possible. Moreover, one or more of the devices of the LPMHTFD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the LPMHTFD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the LPMHTFD 202 that may efficiently provide a platform for implementing a method for using an AI/ML model support a low power multi-horizon time forecasting that provides interpretability including relevance scoring of features considered by the forecasting methodology of the instant disclosure is illustrated, but the disclosure is not limited thereto.

The client devices 208(1)-208(n) may run interface applications, such as standard web browsers or standalone client applications, which may provide an interface to communicate with the LPMHTFD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the LPMHTFD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the LPMHTFD 202, the server devices 204(1)-204(n), or the client devices 208(1)-208(n), for example, may be configured to operate as virtual instances on the same physical machine. For example, one or more of the LPMHTFD 202, the server devices 204(1)-204(n), or the client devices 208(1)-208(n) may operate on the same physical device rather than as separate devices communicating through communication network(s) 210. Additionally, there may be more or fewer LPMHTFDs 202, server devices 204(1)-204(n), or client devices 208(1)-208(n) than illustrated in FIG. 2. In some embodiments, the LPMHTFD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

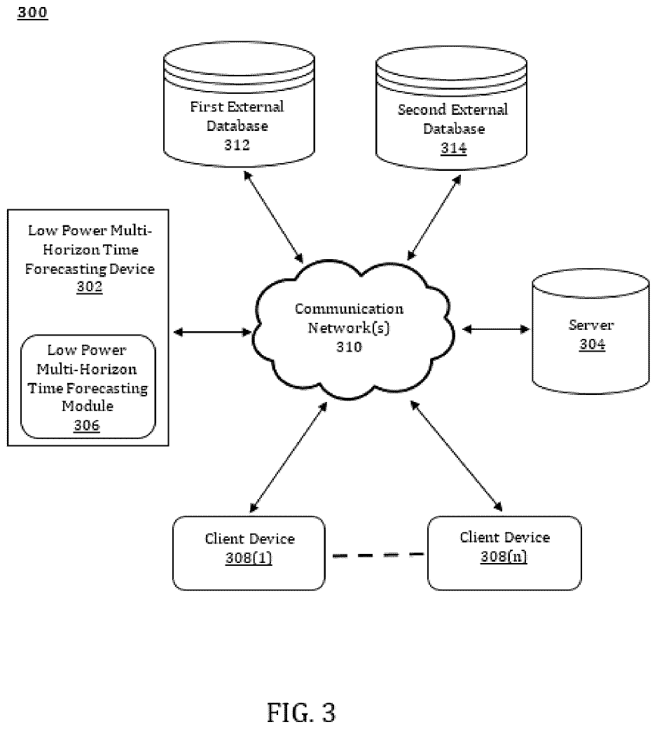

FIG. 3 illustrates a system diagram for implementing an LPMHTFD 302 having a low power multi-horizon time forecasting module (LPMHTFM) that provides interpretability including relevance scoring of features considered by the forecasting methodology of the instant disclosure is illustrated automated transaction reconciliation module (LPMHTFM), in accordance with an embodiment.

As illustrated in FIG. 3, the system 300 may include an LPMHTFD 302 within which an LPMHTFM 306 is embedded, a server 304, a first external database 312, a second external database 314, a plurality of client devices 308(1) . . . 308(n), and a communication network 310.

In some embodiments, the LPMHTFD 302 including the LPMHTFM 306 may be connected to the server 304, and the database(s) 312 via the communication network 310. The LPMHTFD 302 may also be connected to the plurality of client devices 308(1) . . . 308(n) via the communication network 310, but the disclosure is not limited thereto.

In an embodiment, the LPMHTFD 302 is described and shown in FIG. 3 as including the LPMHTFM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the LPMHTFM 306 may be configured to receive real-time feed of data from the plurality of client devices 308(1) . . . 308(n) and secondary sources via the communication network 310.

The plurality of client devices 308(1) . . . 308(n) are illustrated as being in communication with the LPMHTFD 302. In this regard, the plurality of client devices 308(1) 308 (n) may be “clients” (e.g., customers) of the LPMHTFD 302 and are described herein as such. Nevertheless, it is to be known and understood that the plurality of client devices 308(1) . . . 308(n) need not necessarily be “clients” of the LPMHTFD 302, or any entity described in association therewith herein. Any additional or alternative relationship may exist between either or both of the plurality of client devices 308(1) . . . 308(n) and the LPMHTFD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the LPMHTFD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The LPMHTFD 302 may be the same or similar to the LPMHTFD 202 as described with respect to FIG. 2, including any features or combination of features described with respect thereto.

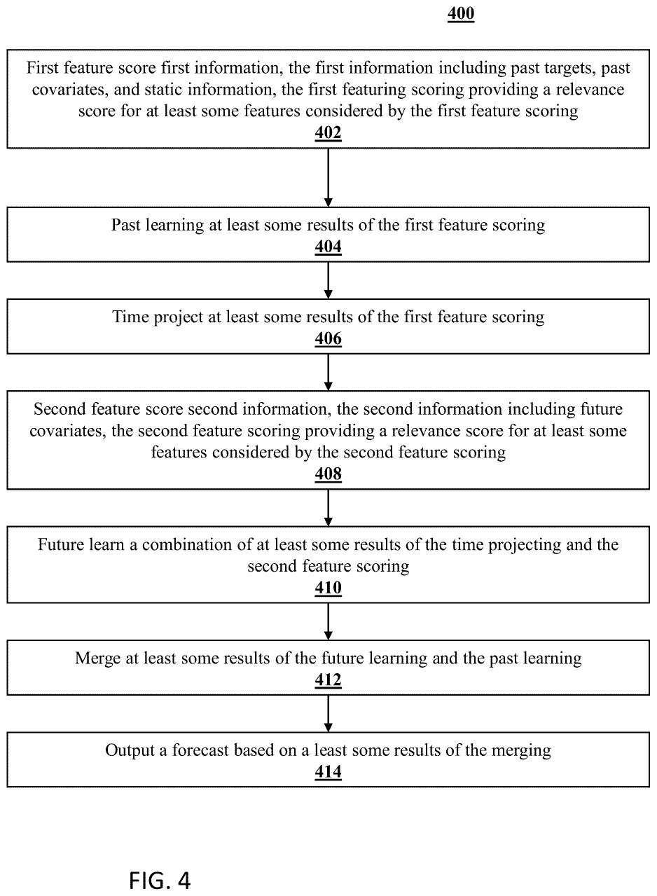

FIG. 4 illustrates an exemplary flow chart of a process 400 implemented by the LPMHTFM 306 of FIG. 3 for enablement of a system and a method for using an AI/ML model to support a low power multi-horizon time forecasting methodology that provides interpretability including relevance scoring of features considered by the forecasting methodology, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include first feature scoring first information, the first information including past targets, past covariates, and static information. The first featuring scoring provides a relevance score for at least some past targets, past covariates, and static information, which contributes to the overall interpretability of process 400.

At step 404, process 400 may include past learning at least some results of the first feature scoring.

At step 406, process 400 may include time projecting at least some results of the first feature scoring.

At step 408, process 400 may include second feature scoring second information, the second information including future covariates. The second feature scoring provided a relevance score for at least some future covariates, which contributes to the overall interpretability of process 400.

At step 410, process 400 may include future learning a combination of at least some results of the time projecting and the second feature scoring.

At step 412, process 400 may include merging at least some results of the future learning and the past learning, where the merging may include applying cross attenuation.

At step 414, process 400 may include outputting a forecast based on at least some results of the merging. The relevance scores provided by the first feature scoring and the second feature scoring provides interpretability for the forecast.

The overall methodology considers a time series dataset D with K unique entities each with n samples. Inputs include all past information within a finite look-back window L, using target and known inputs only up until and including the forecast start time t. Let

$$X ∈ {ℝ}^{K \times L \times C}$$

represent the target time series observations within a lookback window of length L, where C is the number of target variables.

Additional historical information, such as covariates, is denoted as

$${X}_{aux} ∈ {ℝ}^{K \times L \times {C}_{x}}$$

with Cx covariates. Each entity K is associated with a set of static features, that do not vary over time, represented as

$$S ∈ {ℝ}^{K \times 1 \times {C}_{s}}$$

where Cs is the number of time-invariant features.

A goal is to forecast the target

$$Y ∈ {ℝ}^{K \times T \times C}$$

simultaneously for T future time steps i.e. T E {t+1, . . . , t+T} for T future time steps. The methodology may additionally incorporate any known future information

$${Y}_{aux} ∈ {ℝ}^{K \times L \times {C}_{y}}$$

where Cy represents the number of variables of known future information. The aim is to predict Y with X, Xaux, S, and Yaux as inputs.

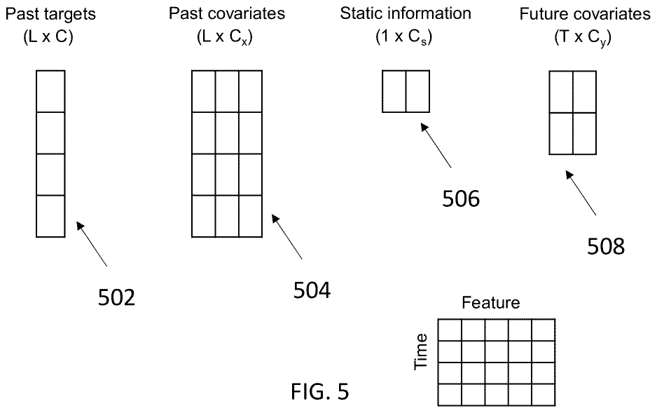

Referring now to FIG. 5, inputs for multi-horizon forecasting as may be performed by the LPMHTFD include past targets 502, past covariates 504, static information 506, and future covariates 508.

Past targets 502 are specific values set in previous periods (e.g., past months, quarters, or years) and used as a reference for measuring performance. These targets represent expectations or objectives that were aimed for in the past and can serve as a baseline for comparison when forecasting future outcomes. By way of non-limiting example in energy forecasting, past targets could be prior targets set for energy consumption. Past targets 502 are represented as a matrix dimensioned L×H.

Past covariates 504 are factors that are not part of the target time series but can influence the forecasted outcome. By way of non-limiting example in energy forecasting, past covariates could be prior weather conditions that could influence heating/cooling as energy consumption. Past covariates 504 are represented as a matrix with dimensions L×Cx.

Static information 506 refers to information that does not change but could affect the forecasting. By way of non-limiting example in energy forecasting, static information could be the insulation of a building that influences heat retention/loss as it bears on energy consumption. Static information 506 represents as a matrix with dimensions 1×Cs.

Future covariates 508 are external variables or factors that are expected to influence the forecasted outcome in future periods. By way of non-limiting example in energy forecasting, future covariates could include forecasted weather conditions (e.g., a cold front or a heat wave is expected to arrive next week) that could influence heating/cooling as energy consumption. Past covariates 504 are represented as a matrix with dimensions T× Cy.

FIG. 5 shows a non-limiting example of L=4, T=2, C=1, Cx=3, Cy=2, and Cs=2. However, the invention is not so limited, and any values may be used. In practical use, these values may be in the hundreds or thousands.

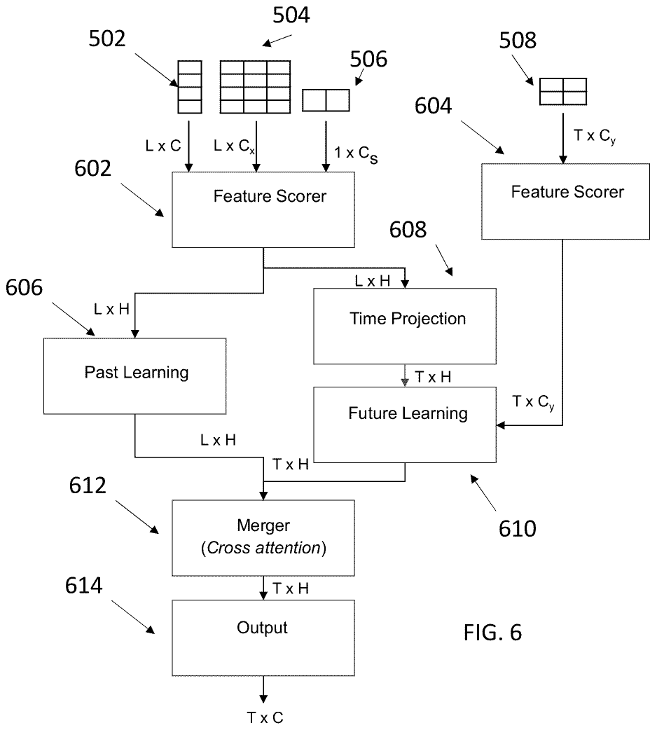

Referring now to FIG. 6, the future covariates 508 will initially be processed independently from the past targets 502, past covariates 504, and static information 506. The past targets 502, past covariates 504, and static information 506 are input to a feature scorer module 602 that provides feature scoring of the noted inputs. Feature scoring assigns a score to each input feature based on its importance or contribution to the model's prediction, which can indicate how much each feature helps the model in making accurate forecasts. Feature scorer module 602 will thus provide relevancy scores for the past targets 502, past covariates 504, and static information 506.

An output of feature scorer module 602 represents as a matrix with dimensions L×H, where His a predetermined number associated with the feature scorer module 602. Since the future covariates 508 were not input to feature scorer module 602, the future covariates 508 were not considered by feature scorer module 602.

The future covariates are input to a feature scorer module 604 that provides feature scoring of the future covariates 508, and provides a relevancy score for each of the future covariates 508. An output of the feature scorer module 604 presents as a T×Cy matrix. Since the past targets 502, past covariates 504, and static information 506 were not input to feature scorer module 604, they were not considered in feature scorer module 604.

The output of feature scorer module 602 is input to a past learning module 606 that provides past learning of the noted inputs. An output of past learning module 606 presents as an L×H matrix, where His a predetermined number associated with the feature scorer module 602.

The output of feature scorer module 602 is also input to a time projection module 608 that provides time projection of the noted inputs. An output of time projection module 608 presents as a T×H matrix.

An output of the time projection module 608 and an output of the feature scorer module 604 are input to a future learning module 610. An output of a future learning module 610 presents as a T×H matrix.

Outputs of past learning module 606 and future learning module 610 are input to a merger module 612 that merges the two using cross attention that defines relationships between the past and the future. An output of a merger module 612 presents as a T×H matrix.

An output of the merger module 612 is input to an output module 614 that applies a fully connected layer that learns the transformation from the T×H representation to generate forecasts with dimensions T×C.

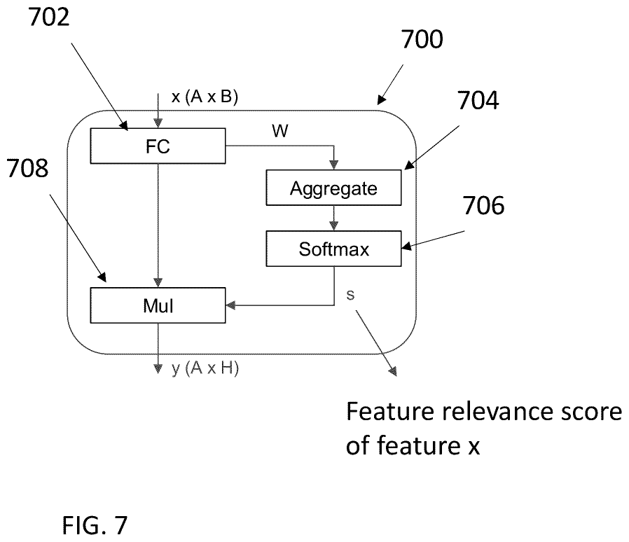

Referring now to FIG. 7, a feature scoring module 700, which may be feature scorer modules 602 and/or 604, is shown. Feature scoring module 700 learns hidden representations of the inputs while simultaneously computing feature relevance scores. Feature scoring module 700 includes a fully connected layer 702, the output of which inputs to an aggregator 704 and a Softmax 706 where the aggregated weights of the layer are normalized to generate feature relevance scores that will provide the interpretability for the model itself. These normalized scores are then multiplied by the corresponding hidden representations for each feature, effectively weighting the importance of each input.

Mathematically, given a feature input x ∈ [symbol] , feature scoring module 700 outputs learned hidden representation y ∈ [symbol] , where H is the hidden dimension, and feature relevance scores sₓ ∈ [symbol] , results of feature scoring module 700 is represented by the equations:

$${s}_{x} = σ ( {W}_{s}^{T} I ) , {s}_{x} ∈ {ℝ}^{d}$$

$${x}_{w} = x ⊙ {s}_{x} , {x}_{w} ∈ {ℝ}^{n \times d}$$

$$y = {x}_{w} {W}_{p}^{T} + b$$

where W is the weight matrix of the linear layer, Wₛ ∈ [symbol] has one weight per input feature (dimension d), summing weights across this dimension provides a score for each feature, layer, Wₚ ∈ [symbol] is the learned projection matrix for transforming input, layer, b ∈ [symbol] is the basis and o is a normalizing function such as softmax.

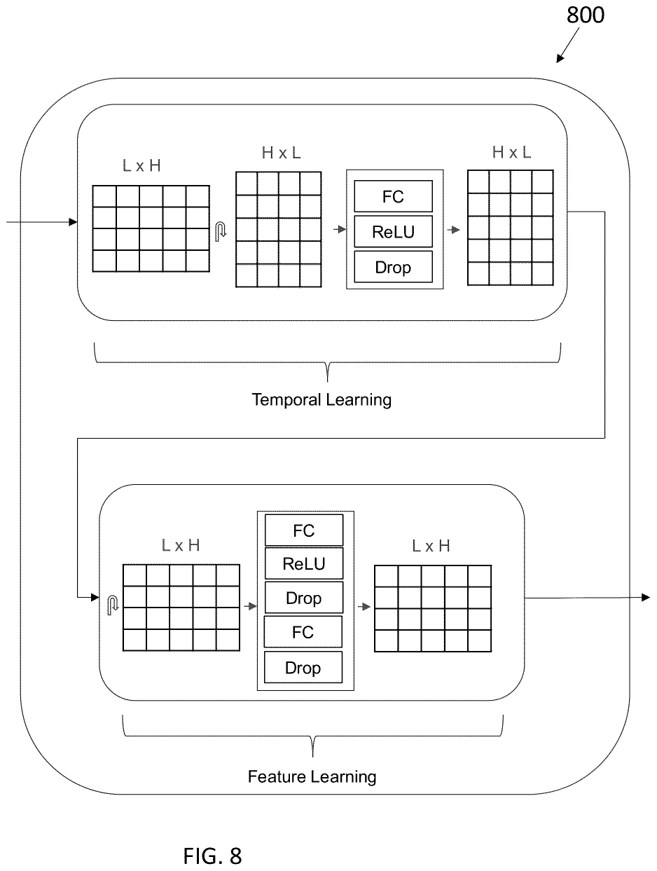

Referring now to FIG. 8, a learning module 800, which may serve as past learning module 606 and/or future learning module 610, is shown. Learning module 800 captures temporal patterns and cross-variate interactions among all features. The methodology leverages concepts from Tolstikhin, Ilya O., et al. “Mlp-mixer: An all-mlp architecture for vision.” Advances in Neural Information Processing systems 2021, the contents of which are incorporated herein by reference in its entirety. Learning module 800 first processes information in the temporal dimension, followed by the feature dimension. These blocks include multilayer perceptron (MLP) layers for the time domain, followed by MLP layers for the feature domain, both connected via skip connections defined by:

$${X}_{time} = X + TM ( X ) ,$$

$${X}_{feature} = {X}_{time} + FM ( {X}_{time} ) ,$$

$$Y = {X}_{feature} .$$

$$TM ( X ) = {Norm}_{after} ( X + Tr ( Dropout ( σ ( FC ( Tr ( {Norm}_{before} ( X ) ) ) ) ) ) )$$

$$FM ( X ) = {Norm}_{after} ( {FC}_{proj} ( X ) + {Dropout}_{2} ( {FC}_{2} ( {Dropout}_{1} ( σ ( {FC}_{1} ( {Norm}_{before} ( X ) ) ) ) ) ) )$$

Where TM is a Time Mixing module, FM is a Feature Mixing Module. FC refers to a fully connected layer, \sigma is softmax, Norm is normalizing operation and Tr refers to transpose.

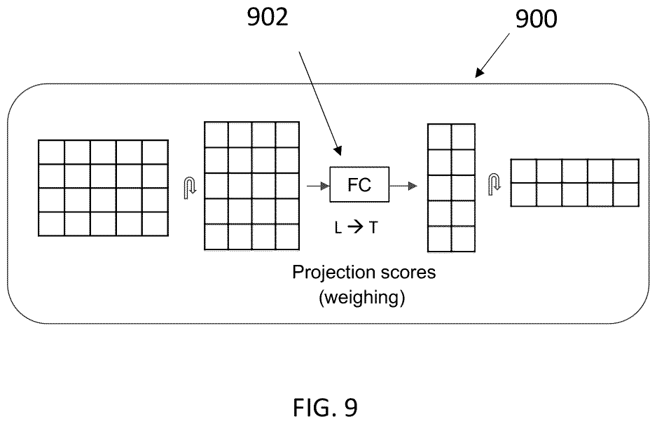

Referring now to FIG. 9, a time projecting module 900, which may serve as time projecting module 608, is shown. Time projecting module captures temporal patterns and maps the time series from the original input length L to the target forecast length T. The module employs a fully connected layer 902 to learn temporal relevance scores for this mapping, providing insights into the importance of past time steps for predicting future time steps.

Mathematically, given an input x ∈ [symbol] , time projecting module 900 outputs learned mapping y ∈ [symbol] where m is the transformed dimension to T, and time relevance scores Sₜ ∈ [symbol] that indicate the importance of each past time step for predicting the future, then results of time projecting module 900 is represented by the equations:

$${s}_{t} = σ ( {\sum }_{i = 1}^{n} {W}_{t} [ : , i ] ) , {s}_{x} ∈ {ℝ}^{m}$$

$$z = {xW}^{T} + b , z ∈ {ℝ}^{H \times m}$$

$$y = z ⊙ {s}_{t} , y ∈ {ℝ}^{m \times H}$$

where W is the weight matrix of the linear layer, b ∈ [symbol] is the basis and o is a normalizing function such as softmax.

Time projection module 900, when used as time projecting module 608, takes input of dimension L×H from the feature scorer module 602, which processes past information and outputs mapped representation of dimension T×H. The rationale behind this branching is that, for past inputs, the methodology can anticipate replacing these with known future inputs. The objective is to project this modified input across future time steps, effectively representing the input as it evolves into the future.

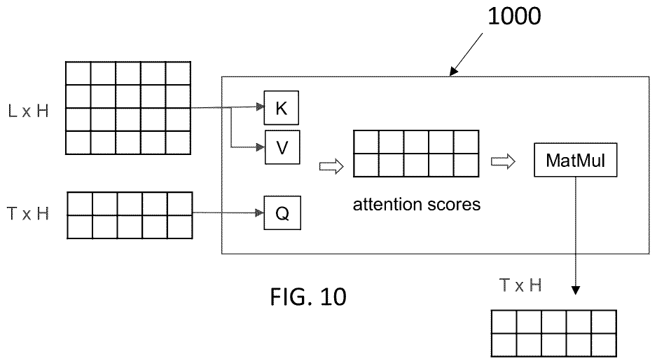

Referring now to FIG. 10, a merger module 1000, which may serve as merger module 612, is shown. K (Key) represents the features or embeddings used to match against the query. V (Value) represents the data or embeddings that the model will attend to after determining their relevance using the keys and queries. K and V are learned from the past branch. Q (Query) represents the feature or embedding for which the model is seeking relevant information. In the above methodology it is the hidden representation learned from the future branch.

Merger module 1000 produces learned hidden representations with dimensions T×H. This merger may be accomplished through a cross-attention mechanism with k attention heads, where attention is applied to the interaction between the past and future representations.

Merger module 1000 takes an input A, representing the output of the future learning module 610, and B representing the output of the past learning module 606, and generates an output C representing transformed representation based on inputs, and summarized by:

$$Y = {softmax ( \frac{{FW}_{q}^{T} ( {PW}_{k}^{T} )}{\sqrt{{d}_{h}}} )}^{T} {PW}_{v}^{T} {W}_{o}^{T}$$

Where Wₖ ∈ [symbol] ,
W_{q} ∈ [symbol] ,
Wᵥ ∈ [symbol] , and
Wₒ ∈ [symbol] ,
are learnable projection matrices, and

$${d}_{h} = \frac{H}{h}$$

is the number of attention heads.

Merger module 1000 treats past representations as the “source language,” and the future representations as the “target language,” analogous to machine translation models where attention helps align and transfer information between different sequences. The attention processing in the merger module 1000 identifies which past time steps are most relevant for predicting future time steps. This provides insights into temporal importance, enabling the model to emphasize critical past inputs while making future predictions. The merger's matrix multiplication (MatMul) layer produces a representation of dimensions T×H.

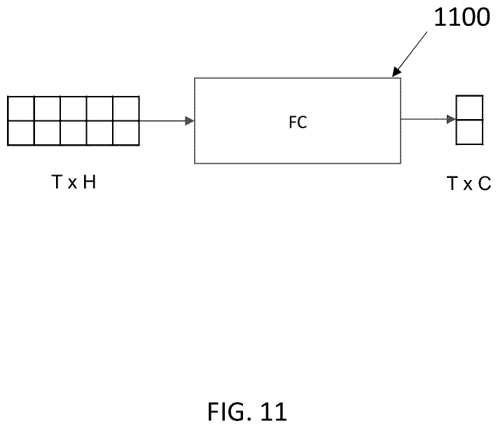

Referring now to FIG. 11, and output module 1100, which may serve as output module 614, is shown. Output module 1100 may be implemented as a fully connected layer that learns the transformation from the T×H representation to generate forecasts with dimensions T×C.

The above methodology provides a technical solution to the technical problems of the prior art. The feature scorer module 602 and the feature scorer model 604 provide relevance scores for the input parameters, such that the methodology provides a high degree of interpretability consistent with TFT and much higher than SparseTSF. It achieves high interpretability using fewer parameters than TFT (on the order of less than 5%), with training time per epoch consistent with SparseTFS and on the order of 30+% lower than TFT. The methodology thus provides interpretability information on par with TFT for only a fraction of the computer resources and electrical power requirements of TFT.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for performing a multi-horizon forecast, the method comprising:
first feature scoring first information, the first information including past targets, past covariates, and static information, the first featuring scoring providing a relevance score for at least some features considered by the first feature scoring;
past learning at least some results of the first feature scoring;
time projecting at least some results of the first feature scoring;
second feature scoring second information, the second information including future covariates, the second feature scoring providing a relevance score for at least some features considered by the second feature scoring;
future learning a combination of at least some results of the time projecting and the second feature scoring;
merging at least some results of the future learning and the past learning;
outputting a forecast based on a least some results of the merging; and
wherein the relevance scores provided by the first feature scoring and the second feature scoring provides interpretability for the forecast.

2. The method of claim 1, wherein the first feature scoring is independent of the future covariates.

3. The method of claim 1, wherein the first feature scoring comprises:
first feature classifying the first information through a first feature classification layer;
first aggregating at least some of the results of the first feature classifying with a first aggregator;
first normalizing at least some of the results of the first aggregating; and
first multiplying at least some of the results of the first feature classifying with at least some of the results of the first normalizing.

4. The method claim 3, wherein the first normalizing outputs the relevance scores of the past targets, the past covariates, and static information.

5. The method of claim 1, wherein the second feature scoring is independent of the past targets, the past covariates, and the static information.

6. The method of claim 1, wherein the second feature scoring comprises:
second feature classifying the first information through a second feature classification layer;
second aggregating at least some of the results of the second feature classifying with a second aggregator;
second normalizing at least some of the results of the second aggregating; and
second multiplying at least some of the results of the second feature classifying with at least some of the results of the second normalizing.

7. The method of claim 6, wherein the second normalizing outputs the relevance scores of the future covariates.

8. The method of claim 1, wherein the merging comprises applying cross attention to at least some of the output of the past learning and the future learning.

9. The method of claim 1, wherein:
the past targets have a sequence length L and a number of targets C, and the first feature scoring had an associated predetermined hidden dimension H;
an output of the first feature scoring is a first matrix with dimensions of L×H;
an output of the past learning is a second matrix with dimensions of L×H;
an output of the time projecting is a third matrix with dimensions of T×H, where Tis a predetermined prediction length;
an output of the future learning is a fourth matrix with dimensions of T×H;
an output of the merging is a fifth matrix with dimensions of T×H; and
an output of the outputting is a sixth matrix with dimensions of T×C.

10. A non-transitory computer readable media storing instructions programmed to cooperate with a processor to perform operations comprising:
first feature scoring first information, the first information including past targets, past covariates, and static information, the first featuring scoring providing a relevance score for at least some features considered by the first feature scoring;
past learning at least some results of the first feature scoring;
time projecting at least some results of the first feature scoring;
second feature scoring second information, the second information including future covariates, the second feature scoring providing a relevance score for at least some features considered by the second feature scoring;
future learning a combination of at least some results of the time projecting and the second feature scoring;
merging at least some results of the future learning and the past learning;
outputting a forecast based on a least some results of the merging; and
wherein the relevance scores provided by the first feature scoring and the second feature scoring provides interpretability for the forecast.

11. The non-transitory computer readable media of claim 10, wherein the first feature scoring is independent of the future covariates.

12. The non-transitory computer readable media of claim 10, wherein the first feature scoring comprises:
first feature classifying the first information through a first feature classification layer;
first aggregating at least some of the results of the first feature classifying with a first aggregator;
first normalizing at least some of the results of the first aggregating; and
first multiplying at least some of the results of the first feature classifying with at least some of the results of the first normalizing.

13. The non-transitory computer readable media claim 12, wherein the first normalizing outputs the relevance scores of the past targets, the past covariates, and static information.

14. The non-transitory computer readable media of claim 10, wherein the second feature scoring is independent of the past targets, the past covariates, and the static information.

15. The non-transitory computer readable media of claim 10, wherein the second feature scoring comprises:
second feature classifying the first information through a second feature classification layer;
second aggregating at least some of the results of the second feature classifying with a second aggregator;
second normalizing at least some of the results of the second aggregating; and
second multiplying at least some of the results of the second feature classifying with at least some of the results of the second normalizing.

16. The non-transitory computer readable media of claim 15, wherein the second normalizing outputs the relevance scores of the future covariates.

17. The non-transitory computer readable media of claim 10, wherein the merging comprises applying cross attention to at least some of the output of the past learning and the future learning.

18. The non-transitory computer readable media of claim 10, wherein:
the past targets have a sequence length L and a number of targets C, and the first feature scoring had an associated predetermined hidden dimension H;
an output of the first feature scoring is a first matrix with dimensions of L×H;
an output of the past learning is a second matrix with dimensions of L×H;
an output of the time projecting is a third matrix with dimensions of T×H, where Tis a predetermined prediction length;
an output of the future learning is a fourth matrix with dimensions of T×H;
an output of the merging is a fifth matrix with dimensions of T×H; and
an output of the outputting is a sixth matrix with dimensions of T×C.

19. A system, comprising;
a processor;
a non-transitory computer readable media storing instructions programmed to cooperate with the processor to perform operations comprising:
first feature scoring first information, the first information including past targets, past covariates, and static information, the first featuring scoring providing a relevance score for at least some features considered by the first feature scoring;
past learning at least some results of the first feature scoring;
time projecting at least some results of the first feature scoring;
second feature scoring second information, the second information including future covariates, the second feature scoring providing a relevance score for at least some features considered by the second feature scoring;
future learning a combination of at least some results of the time projecting and the second feature scoring;
merging at least some results of the future learning and the past learning;
outputting a forecast based on a least some results of the merging; and
wherein the relevance scores provided by the first feature scoring and the second feature scoring provides interpretability for the forecast.

20. The system of claim 19, wherein:
the first feature scoring is independent of the future covariates; and
the second feature scoring is independent of the past targets, the past covariates, and the static information.
